(19) United States
(12) Patent Application Publication
(10) Pub. No.: US 2009/0173233 A1
(43) Pub. Date: Jul. 9, 2009

(54) Illuminating filter for particle controlled environments

(75) Inventors: Larry M. Ottesen, Brentwood, CA (US); James M. Harris, Livermore, CA (US)

Correspondence Address: John E. Menear, 1200 Capitola Road, #4, Santa Cruz, CA, 95062, US

(73) Assignee: TES-Clean Air Systems

(21) Appl. No.: 12/313,531

(22) Filed: Nov. 21, 2008

Related U.S. Application Data
(60) Provisional application No. 61/009,893, filed on Jan. 3, 2008.

(51) Int. Cl. B01D 46/42; B23P 15/00

(52) U.S. Cl. 96/226; 55/385.1; 29/896.62

(57) ABSTRACT

An illuminating filter which provides both clean air and light into a particle controlled environment. The integration of filtration and lighting simplifies the design of cleanrooms, mini-environments, and clean zones. Space savings and cost savings are served by integrating filtration and lighting into a single structure. Light emitters, such as LEDs or other solid state devices, may be used where low voltage or low current is desirable.

### CROSS-REFERENCE TO RELATED APPLICATIONS

This application claims priority to U.S. Provisional Application 61/009,893 (confirmation number 6603) filed Jan. 3, 2008 by Larry Ottesen and James Harris entitled, “ILLUMINATING FILTER FOR PARTICLE CONTROLLED ENVIRONMENTS”.

### STATEMENT REGARDING FEDERALLY SPONSORED RESEARCH

Not Applicable

### REFERENCE TO A MICROFICHE APPENDIX

Not Applicable

### BACKGROUND OF THE INVENTION

1. Field of the Invention

This invention relates to filters which are used to remove particles or airborne molecular contaminants from clean environments. Clean environments include cleanrooms, mini-environments, or controlled work zones as defined by ISO Standard 14644. In particular, the instant invention addresses clean environments where lighting is utilized. This invention combines the filter and the lighting into a single unit.

2. Description Of Related Art

Filters for removing particles from air (or other gases, such as nitrogen or argon) are a basic element of a clean work zone. Common filter categories include HEPA and ULPA, but this invention is independent of filter category.

Filters include a filter media and a filter flame. The filter frame holds and supports the filter media via adhesive attachments. Filter frames surround the filter media, and filter frames may have cross members.

The filter media traps particles which flow through it. Until the late 1990s, filter media was largely produced from borosilicate glass fibers. Modern filters for semiconductor application commonly use PTFE fibers.

Regardless of fiber type, the fibers form a barrier to particle penetration. Particles larger than 0.3 micron are mainly trapped by impaction, and particles smaller than 0.1 micron are mainly trapped by diffusion. Quality control testing of filters is normally performed at 0.10 to 0.15 micron.

Most particle controlled environments also require lighting. In an operating cleanroom, personnel are present. Sufficient lighting for vision is needed. In mini-environments, solid walls may partially block entry of ambient light. Internal lighting permits an outside operator to see inside.

Historically, filtration and lighting have been viewed as two separate issues. Designers of clean work zones specify the number of filters and the size of the filters. Designers also specify the number of lights, the placement of lights, and the intensity of lights.

However, filters and lights may be designed at different times by different designers. Filters and lights are likely ordered from different vendors. This leads to at least three inefficiencies.

First, a separate position for lighting is required. When the lights are built into a mini-environment wall, the mini-environment frame has to be designed to include a lighting section. Then connectors to fasten the lights to the mini-environment frame must be added.

Second, wiring must be routed through a mini-environment frame to access the lights. In the case of fluorescent lights, 115 volt to 230 volt safety measures must be addressed.

Third is coordination. In general, the probability of error increases when components are handled separately. Consider a scenario wherein a purchasing paperwork error results in a mini-environment frame error, and the lighting section prevents the filter from sealing properly.

An analogous set of problems exist for a cleanroom or clean zone installation. Filters or fan-filter modules are sized to fit a ceiling (for vertical air flow). Then lighting is added downwind of the filter.

A feature of the prior art is that lights are not an integral part of the filter itself. Prior art lights are built into a cleanroom ceiling or a clean zone wall or a mini-environment frame or other non-filter structure.

The prior art includes flow-through modules, which incorporate a filter plus one or two fluorescent lights. In this structure, the fluorescent lights are connected to the flow-through module frame and the filter is attached to the flow-through module frame. But the lights are not located within the boundaries of the filter frame. Further, electrical wires are not routed to or through the filter frame.

Prior art lights have a distinguishing feature: they are not physically located between the inlet and outlet planes of the filter frame.

There is a need for an integrated solution that places the lights between the inlet and outlet planes of the filter frame. An integrated solution obviates problems associated with excess costs, separate wiring, and over-lapping design.

### BRIEF SUMMARY OF THE INVENTION

Following is a condensed summary. By necessity, details are omitted in order to simply state the essence of the invention. Omitted details within this section should not be construed in a way that limits the scope of the invention.

This invention, an illuminating filter, is a filter with integrated illumination segments. Illumination segments are positioned between the inlet and outlet planes of the filter flame.

An illuminating filter differs from the prior art because: (a) the illuminating filter can perform both filtration and lighting, (2) the illuminating filter can be made, used, or sold as a single structure, and (3) lights or illumination segments of an illuminating filter are disposed between the inlet and outlet planes of the filter flame.

The inlet plane of the filter frame includes the outside surface of the filter frame which faces toward the inlet air. The outlet plane of the filter flame includes the outside surface of the filter frame which faces toward the outlet air.

By combining the filter and lights into one unit, problems associated with the prior art are resolved. A separate light section is no longer required. Wiring to the lights is simplified. Design and manufacturing errors are minimized.

In addition to minimizing negative factors inherent in the prior art, the illuminating filter also presents positive opportunities. For example, when low voltage solid state illumination sources are incorporated, safety considerations are reduced and designers realize more flexibility. Also, solid state lights have a longer mean-time-between-failure than either fluorescent or incandescent lights. This translates into reduced maintenance.

Light sources or illumination segments are located within the volume of space defined by the outer surfaces of the filter frame. In one variation, the light sources divide the filter media into two parts along the long filter dimension. In a second variation, the light sources divide the filter media into two parts along the short filter dimension. In a third variation, the light sources divide the filter media obliquely into two parts. In a fourth variation, the light sources are disposed at the perimeter of the filter media.

Among many other application areas, this instant invention is applicable to mini-environments and cleanrooms. It also can be applied to diffusers, which receive and distribute clean air or gases (such as nitrogen or argon).

Industries within which illuminating filters have benefit include (but are not limited to) semiconductor, pharmaceutical, disk drive, flat panel display, solar energy, and MEMS.

Objects of this Invention Include:
(a) provide a filter or fan-filter module with integrated lights,
(b) position lights or illumination segments within the volume of space (length, width, and height) defined by the outer surfaces of the filter frame,
(c) provide a one-piece solution for both filtration and lighting,
(d) utilize solid state lights where appropriate,
(e) allow the use of low voltage power.

### BRIEF DESCRIPTION OF THE SEVERAL VIEWS OF THE DRAWINGS

FIG. 1 shows a typical prior art filter. This filter does not incorporate an illumination segment.

FIG. 2 shows a prior art filter that is constructed with a cross member included in the filter frame. This filter does not incorporate an illumination segment.

FIG. 3 diagrams a prior art fan-filter module. A fan-filter module contains blowers, a housing, and a filter. Inlet and outlet planes of the filter frame are visualized.

FIG. 4 illustrates one embodiment of an illuminating filter. This invented illuminating filter provides both filtered air plus light. An illumination segment is disposed parallel to the short dimension of the illuminating filter.

FIG. 5 illustrates one method of integrating light emitters into an illuminating filter. In this diagram, the illumination segment utilizes a cross member of a filter frame. Inlet and outlet planes of the filter frame are visualized.

FIG. 6 diagrams an illuminating filter, wherein the illumination segment is disposed parallel to the long dimension of the illuminating filter.

FIG. 7 shows an illuminating filter, wherein the illumination segment is not disposed parallel to either the long dimension or the short dimension of the illuminating filter.

FIG. 8 shows an illuminating filter, wherein the light emitters are attached to the perimeter of the filter frame.

FIG. 9 illustrates an illuminating filter, wherein the light emitter is one continuous light emitting structure as opposed to an ensemble of discrete light emitters.

FIG. 10 shows an illuminating filter that has been incorporated into a fan-filter module.

FIG. 11 illustrates an illuminating filter incorporated into a fan-filter module. The fan-filter module is further incorporated into a mini-environment or clean zone.

### DETAILED DESCRIPTION OF THE INVENTION

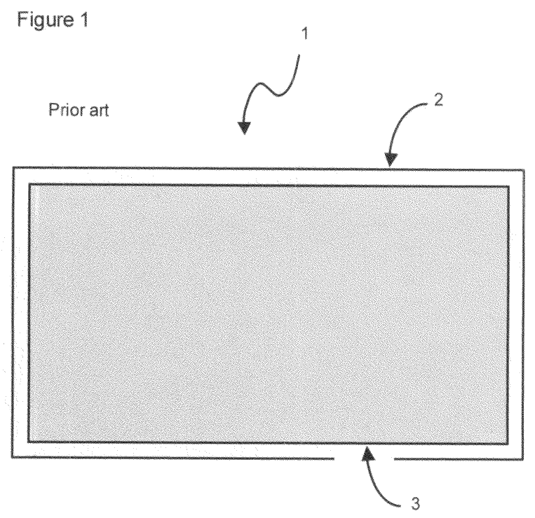

FIG. 1 shows a prior art air (or gas) filter 1. Filters are used in clean zones, which are categorized into nine classes by ISO Standard 14644. This is a planar view, and the view is perpendicular to the direction of air flow. The filter media 3 removes particles from the air as air passes through the filter media 3. Although filters 1 are discussed in terms of air filtration, filters 1 are also used to filter other gases, such as nitrogen or argon.

Filter media 3 is fragile, and must be attached to a filter frame 2. The filter frame 2 provides structural rigidity and support for the filter media 3. When a filter 1 is manually handled, it is picked up with the filter frame 2. Filter frames are typically constructed from passivated metal. For example, aluminum passivated by a layer of aluminum oxide is commonly chosen for construction.

Filter media 3 may include borosilicate glass fibers, PTFE (polytetrafluoroethylene), or other materials. Filtration efficiencies are chosen to match the application. Low efficiency filters 1 are used in non-critical clean zones. HEPA (high efficiency particulate air) or ULPA (ultra low particulate air) filters 1 are currently used in more critical applications, such as semiconductor, disk drive, pharmaceutical, flat panel display, solar panel, and MEMS production. The filter media 3 is typically attached to the filter frame 2 via an adhesive.

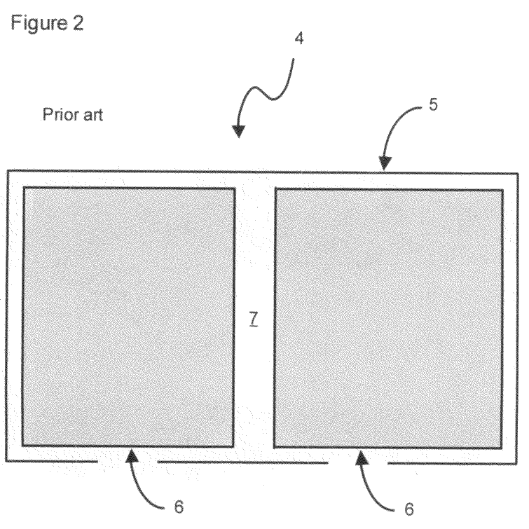

FIG. 2 shows another prior art filter 4. Here the filter frame 5 possesses a cross member 7 which divides the filter media 6 into two pieces.

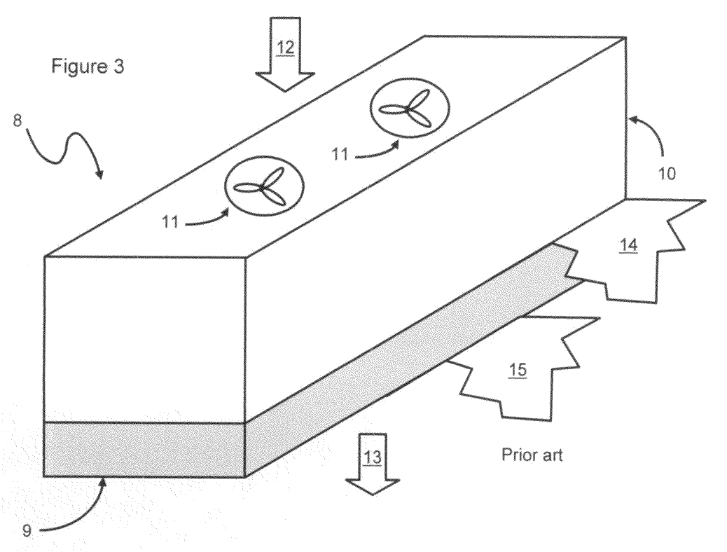

FIG. 3 shows a fan-filter module 8, which is a prior art commercial filtration product. The fan-filter module 8 uses blowers 11 to draw air (or gas) from the environment and build a positive air pressure inside a housing 10. The positive pressure causes air to flow through the filter 9. The filter 9 has an inlet plane 14 (top outside surface of the filter frame) and an outlet plane 15 (bottom outside surface of the filter frame). As shown, inlet air 12 flows into the housing 10, and outlet air 13 flows outward from the housing 10 through the filter 9. The outlet air 13 is directed into a clean zone.

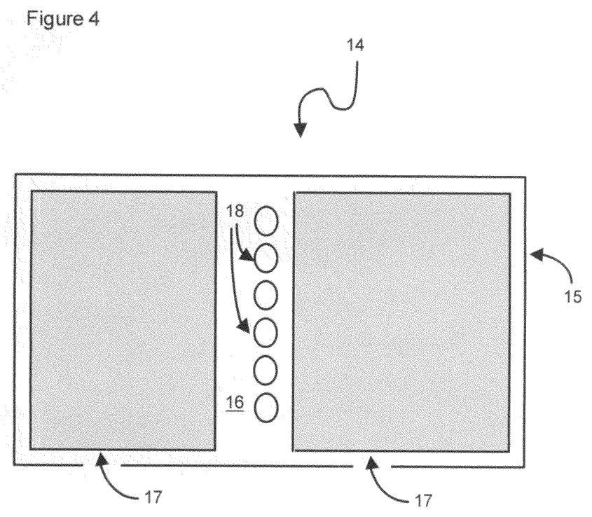

FIG. 4 shows one embodiment of an illuminating filter 14. In this embodiment, the filter frame 15 possesses an illumination segment 16 that divides the filter media 17 into two portions. The illumination segment 16 includes a series of light emitters 18. Light from the illumination segment 16 is directed in the same direction as the clean air flow. The two portions of filter media 17 can take a variety of shapes. For example, the two portions may be equal in size or unequal. The geometrical shapes may be the same or different since the illumination segment 16 may connect to any two sides of the filter frame 15. The illumination segment 16 may be parallel, perpendicular, or oblique to either the pleat end or cut end of the filter media.

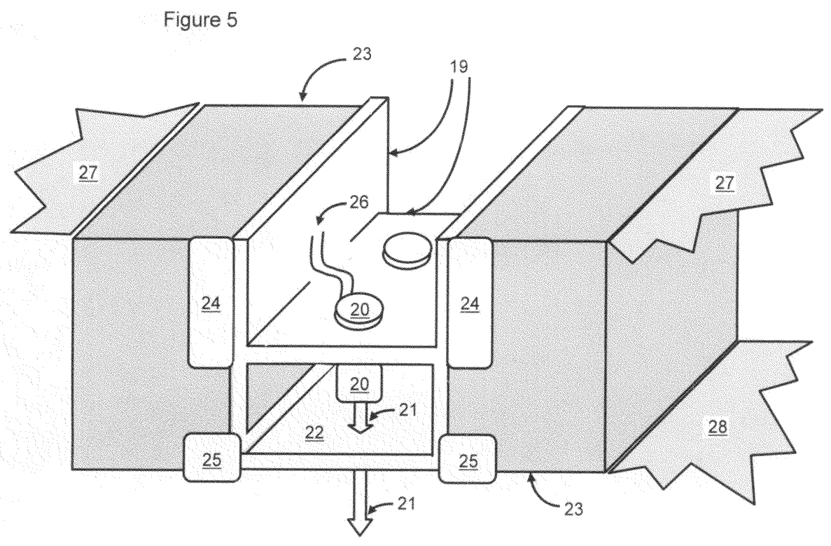

FIG. 5 shows one example of connecting light emitters 20 to a cross member 19 which divides the filter media 23 into two sections. In this example, the light emitters 20 pass through an opening in the cross member 19. Electrical wires 26 are routed through a hollow section of the cross member 19, and supply power to the input side of the light emitters 20. Light 21 from the light emitter 20 passes through a light cover 22. The light cover 22 protects the light emitters 20 from handling damage. Note that the light emitters 20 are located between the filter's inlet plane 27 and the filter's outlet plane 28. No portion of the light emitters extends outward beyond the inlet plane or beyond the outlet plane 28. Light emitter spacing along the cross member 19 is variable, depending on application. For example, light emitters 20 could be 3 inches apart or 0.5 inches apart. Or, light emitters 20 could be disposed in a quasi-continuous pattern.

In addition, the light cover 22 can serve to filter the light 21. Light filtration has value in photolithography equipment and other processes where photochemical reactions can be detrimental. For example, filtering the light between 300-550 nm shifts the transmitted light distribution toward yellow and red. A reasonable filtration target for photolithography is removal of 2% of total emitted light within the frequency range of 300 nm to 550 nm. However, actual removal percentages and spectral ranges are determined on a case-by-case basis to fit the application.

Whenever a cross member 19 divides filter media 23 into pieces, media sealing 24 at each interface is needed. The same adhesive normally used for attaching filter media to a filter frame may be used. Media sealing 24 may occur on the cut end or the pleat end of the filter media 23, depending on orientation.

The light cover 22 is also sealed to the filter frame, the cross member 19, the filter media, or any combination with cover sealing 25. The cover sealing 25 again comprises an adhesive.

The light cover 22 may be used in a pharmaceutical facility or a hospital. So, the light cover 22 must be compatible with bactericides, fungicides, alcohols, and oxidizing agents. Perchlorates are oxidizing agents that may be present in bactericides and fungicides.

Attachment of the light emitters 20 to the cross member 19 may utilize a variety of fastening mechanisms. For example, quarter-turn screws, flanges, threading, gluing, tapered holes may be used. This fastener list is not intended to be complete, and a plethora of commercially available fasteners are applicable. For ease of replacement or service, light emitters 20 may be attached to a retainer that detachably fits onto the cross member 19, and remain within the inventive concept.

Spacing of the light emitters 20 is variable. For high intensity lighting, light emitters 20 may be positioned such that the less than ½ inch separates adjacent surfaces between neighboring light emitters 20. For medium intensity light, light emitters 20 may be positioned such that ½ to 3 inches separate adjacent surfaces between neighboring light emitters 20. For low intensity light, light emitters 20 may be positioned with more than 3 inches between neighboring light emitters 20.

A useful known category of light emitters 20 are devices that convert either current or voltage to light. Some of these are solid state devices. Within the solid state category are LEDs (light emitting diodes).

Solid state light emitters 20 can operate at low voltages. Electrical wires 26 for typical LEDs provide 12-24 volts. Lower voltage solid state devices may operate between 1.5 and 12 volts. Higher voltage solid state devices may operate between 24 and 48 volts.

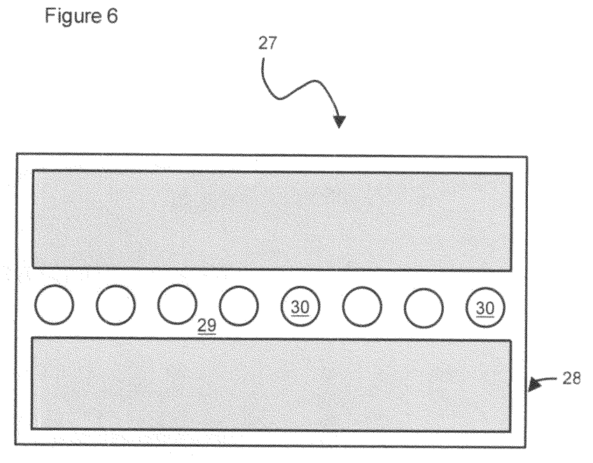

FIG. 6 shows an alternate embodiment of an illuminating filter 27. In this embodiment, the illumination segment 29 is disposed parallel to the long dimension of the filter frame 28. Hence, the light emitters 30 form a line that is aligned with the long dimension of the filter frame 28.

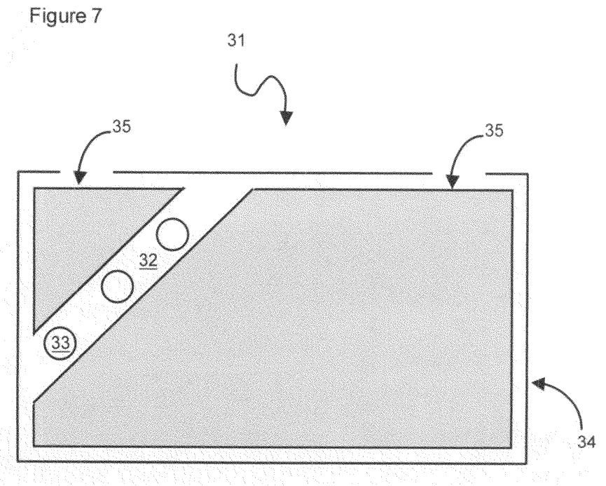

FIG. 7 shows another embodiment of an illuminating filter 31. Note that the illumination segment 32 is not parallel to either the length or width of the filter frame 34. Again, the light emitters 33 are built into the illumination segment 32. This arrangement divides the filter media 35 into pieces with different shapes.

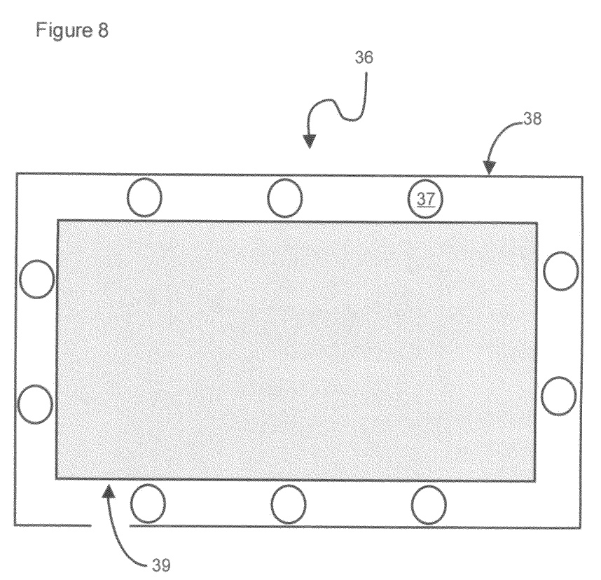

FIG. 8 shows another embodiment of an illuminating filter 36. In this embodiment, the light emitters 37 are disposed within the volume (length, width, height) of the filter frame 38. The filter media 39 is undivided.

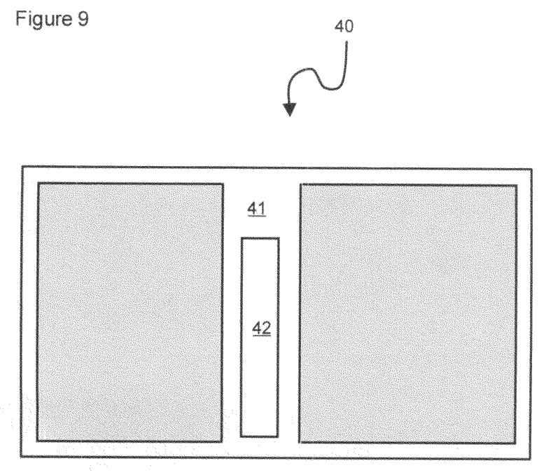

FIG. 9 shows another embodiment of an illuminating filter 40. In this case, the illumination segment 41 contains a continuous light emitter 42 as opposed to a series of discrete solid state devices. Any given area of the light emitter 42 produces substantially the same light output.

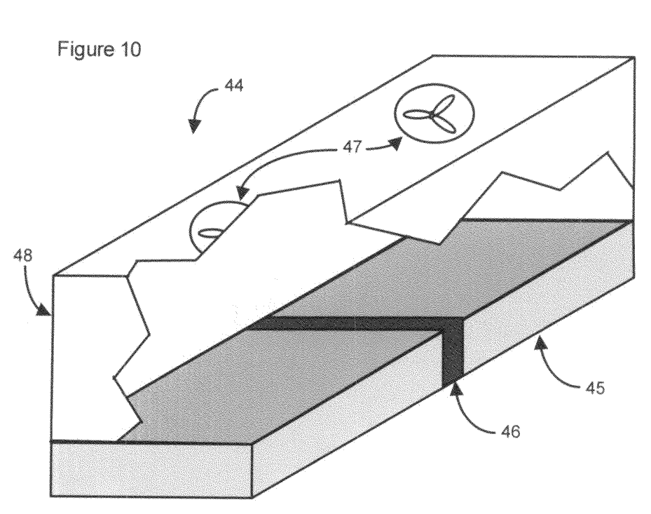

FIG. 10 shows an illuminating filter 45 that has been included into a fan-filter module 44. In this configuration, the blowers 47 pull air from the surrounding environment into a housing 48. Pressure build up inside the housing 48, and drives air through the illuminating filter 45. In this example, the illumination segment 46 is parallel to the short dimension of the illuminating filter 45.

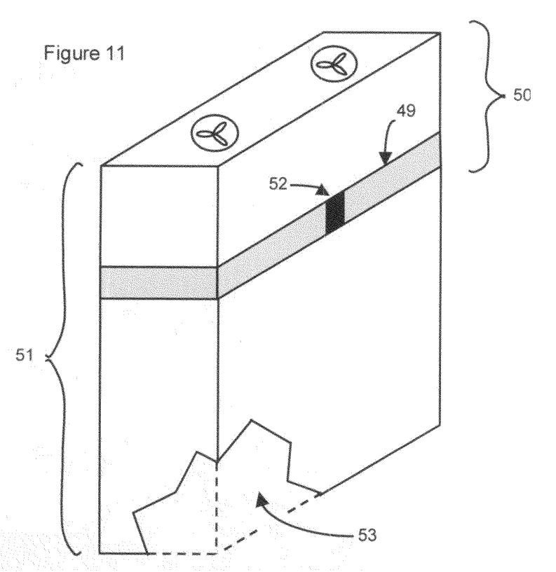

FIG. 11 shows an illuminating filter 49 included into a fan-filter module 50, and the fan-filter module 50 is further included into a mini-environment 51. As shown, the illumination segment 52 is parallel to the short dimension of the illuminating filter 49. Both light and filtered air are directed into the clean zone 53.

The above embodiments are examples of the inventive concept. These examples are designed to clarify the inventive concept, but not to limit the inventive concept. Many variations are possible which remain within the invention scope, and are obvious to those of ordinary skill within the lighting and filtration fields.

Light emitting devices are becoming more efficient with time. The inventive concept is not limited to types of light emitters that are available today or to types of filter media that are available today.

The invention claimed is:

1. An illuminating filter comprising:
one or more sections of filter media,
which remove particles from a gas flowing through said filter media;
a filter frame,
which has an inlet plane through which unfiltered air or gas enters,
which has an outlet plane through which filtered air is delivered, and
which supports said filter media;
one or more illumination segments
which are integrated into said illuminating filter,
which include light emitters,
where said light emitters are disposed between said inlet plane and said outlet plane of said filter frame, and
where no portion of said light emitters extends outward beyond said inlet plane or said outlet plane, and
which direct light to a filtered work space.

2. Claim 1 where integrated means that said filter media, said filter frame, and said illumination segments are combined into a single structure, and that said illuminating filter is manufactured, used, or sold as a single structure.

3. Claim 1 where said gas comprises any one selected from a group consisting of air, nitrogen, and argon.

4. Claim 1 where said filter frame surrounds said one or more sections of filter media.

5. Claim 1 where said filter frame joins to said filter media via an adhesive.

6. Claim 1 where said filter frame contains a cross member which divides said filter media into two or more separated areas.

7. Claim 6 where said cross member is adjoined to any two sides of said filter frame.

8. Claim 1 where said light emitters comprise devices that convert voltage or current to light.

9. Claim 1 where said light emitters are attached to said illumination segment via quarter turn screws, snap-on retainers, flanges, threading, gluing, tapered holes, non-silicone adhesive, silicone adhesive, hot melt glue, rigid wiring harness, or self adhesive retainer.

10. Claim 1 where said illumination segment is overlaid with a light cover.

11. Claim 10 where said light cover removes more that 2% of total emitted light from said illumination segment within the frequency range of 300 nm to 550 nm.

12. Claim 10 where said light cover is chemically compatible with any one selected from a group consisting of bactericides, fungicides, isopropyl alcohol, perchlorates and oxidizing agents.

13. Claim 1 where said filter frame includes a cross member, and said illumination segment is attached to said cross member.

14. Claim 1 where a light cover is disposed over said illumination segment, and said light cover is transparent at those locations through which light is intentionally directed.

15. Claim 1 where a light cover is disposed over said illumination segment, and said light cover is translucent or opaque at locations through which light is not directed.

16. A method of building an integrated illuminating filter comprising:
connecting two or more pieces of filter media to a filter frame and to a cross member,
where said cross member is part of said filter frame, and
where said filter frame includes an inlet plane and an outlet plane;
attaching an illumination segment to said cross member,
wherein said illumination segment includes one or more light emitters
where said light emitters are disposed between said inlet plane and said outlet plane of said filter frame, and
where no portion of said light emitters extends outward beyond said inlet plane or said outlet plane;
sealing said filter media, said illumination segment, and said filter frame,
such that gas on the high pressure side of said illuminating filter is directed through said filter media and into a filtered work space; and
directing light from said light emitters into said filtered work space.

17. Claim 16 where said filter frame includes a perimeter which surrounds said two or more pieces of filter media.

18. An illuminating filter comprising:
two or more sections of filter media,
which remove particles from a gas flowing through said filter media;
a filter frame which includes a cross member, such that
said filter frame with said cross member encloses said sections of said filter media;
one or more illumination segments
which include light emitters, and
which provide light to a filtered work space; and
means for combining said filter media said filter flame and said illumination segments into an integrated unit.

19. Claim 18 where integrated means that said filter media, said filter frame, and said illumination segments are combined into a single structure, and that said illuminating filter is manufactured, used, or sold as a single structure.
